(19) United States
(12) Patent Application Publication
(10) Pub. No.: US 2019/0129205 A1
(43) Pub. Date: May 2, 2019

(54) MOBILE DEVICE AND METHOD FOR CONTROLLING THE SAME

(71) Applicant: HTC Corporation, Taoyuan City (TW)

(72) Inventors: Chi-Jer WANG, Taoyuan City (TW); Kuan-Ku KUO, Taoyuan City (TW)

(73) Assignee: HTC Corporation, Taoyuan City (TW)

(21) Appl. No.: 15/795,409

(22) Filed: Oct. 27, 2017

(51) Int. Cl. G02F 1/01; H04M 1/22

(52) U.S. Cl. CPC G02F 1/0121; H04M 1/22

(57) ABSTRACT

A mobile device and a method for controlling the same are provided. The method comprises the following steps. The mobile device comprising a body and a smart film is provided, wherein the body has a first surface and a second surface facing to the first surface, and the smart film is disposed on a particular area which is located on at least one of the first surface and the second surface. An electrical control signal in response to a particular event of the mobile device is generated. The transparency of the smart film is changed in response to the electrical control signal to change the smart film from a first state to a second state.

### TECHNICAL FIELD

The invention relates in general to a mobile device, and more particularly to a mobile device including a smart film and a method for controlling the same.

### BACKGROUND

Within the recent years, hardware parts of mobile devices are improved to dual core, and even quad core processing. A mobile device can be used as a device to perform all of people's digital needs. Mobile devices are becoming an integral part of people's lives and some of our most vital tools. Mobile devices become an inescapable necessity. When mobile devices are getting more and more powerful, people start pursuing a stylish design, a more sophisticated look and a sleek appearance for mobile devices.

Therefore, there is a need to provide a mobile device and a method for controlling the same to make a mobile device look sleek and stylish.

### SUMMARY

The invention is directed to a mobile device and a method for controlling the same. The mobile device includes a smart film, and the transparency of the smart film could be controlled and adjusted by applying a voltage. The smart film is disposed between a function module and the housing of the mobile device or is disposed between a pattern and the housing. When the smart film is in an opaque state, the function module or the pattern is blocked by the smart film and is not seen by the user. The mobile device could look sleek and stylish. When the smart film is in a transparent state, the user could see the function module or the pattern, and the function module works properly.

According to a first aspect of the present invention, a method for controlling a mobile device is provided. The method comprises the following steps. The mobile device comprising a body and a smart film is provided, wherein the body has a first surface and a second surface facing to the first surface, and the smart film is disposed on a particular area which is located on at least one of the first surface and the second surface. An electrical control signal in response to a particular event of the mobile device is generated. The transparency of the smart film is changed in response to the electrical control signal to change the smart film from a first state to a second state.

According to a second aspect of the present invention, a mobile device is provided. The mobile device comprises a body, a smart film, a signal generating unit, and a control unit. The body has a first surface and a second surface facing to the first surface. The smart film is disposed on a particular area which is located on at least one of the first surface and the second surface. The signal generating unit generates an electrical control signal in response to a particular event of the mobile device. The control unit changes the transparency of the smart film in response to the electrical control signal to change the smart film from a first state to a second state.

According to a third aspect of the present invention, a mobile device is provided. The mobile device comprises a transparent housing, a body, a smart film. The body has a first surface and a second surface facing to the first surface. The smart film is disposed on a particular area which is located on at least one of the first surface and the second surface, and placed between the transparent housing and the body.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram illustrating a mobile device according to one embodiment of the present invention.

FIG. 2 illustrates a flow diagram for a method for controlling a mobile device according to one embodiment of this invention.

FIG. 3A shows a perspective view of a mobile device according to one embodiment of this invention.

FIG. 3B shows a top view of the back surface of a mobile device according to one embodiment of this invention.

FIG. 3C illustrates a cross-sectional view taken along the cross-sectional line A-A′ in FIG. 3B.

FIG. 3D illustrates a schematic diagram of a mobile device when a smart film disposed above a back camera is in an opaque state according to one embodiment of this invention.

FIG. 3E illustrates a schematic diagram of a mobile device when a smart film disposed above a back camera is in a transparent state according to one embodiment of this invention.

FIG. 4A shows a perspective view of a mobile device according to one embodiment of this invention.

FIG. 4B shows a top view of the back surface of a mobile device according to one embodiment of this invention.

FIG. 4C illustrates a cross-sectional view taken along the cross-sectional line B-B′ in FIG. 4B.

FIG. 5A shows a perspective view of a mobile device according to one embodiment of this invention.

FIG. 5B shows a top view of the back surface of a mobile device according to one embodiment of this invention.

FIG. 5C illustrates a cross-sectional view taken along the cross-sectional line C-C′ in FIG. 35.

FIG. 6A shows a perspective view of a mobile device according to one embodiment of this invention.

FIG. 6B shows a top view of the back surface of a mobile device according to one embodiment of this invention.

FIG. 6C illustrates a cross-sectional view taken along the cross-sectional line D-D′ in FIG. 6B.

FIG. 7A shows a perspective view of a mobile device according to one embodiment of this invention.

FIG. 7B shows a top view of the front surface of a mobile device according to one embodiment of this invention.

FIG. 7C illustrates a cross-sectional view taken along the cross-sectional line E-E′ in FIG. 7B.

FIG. 8A shows a perspective view of a mobile device according to one embodiment of this invention.

FIG. 8B shows a top view of the front surface of a mobile device according to one embodiment of this invention.

FIG. 8C illustrates a cross-sectional view taken along the cross-sectional line F-F′ in FIG. 8B.

FIG. 9A shows a perspective view of a mobile device according to one embodiment of this invention.

FIG. 9B shows a top view of the back surface of a mobile device according to one embodiment of this invention.

FIG. 9C illustrates a cross-sectional view taken along the cross-sectional line G-G′ in FIG. 9B.

FIG. 10A shows a perspective view of a mobile device according to one embodiment of this invention.

FIG. 10B shows a top view of the back surface of a mobile device according to one embodiment of this invention.

FIG. 10C illustrates a cross-sectional view taken along the cross-sectional line H-H′ in FIG. 10B.

FIG. 11 shows a top view of the back surface of a mobile device according to one embodiment of this invention.

FIGS. 12A and 12B show top views of the back surface of a mobile device according to one embodiment of this invention.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. Descriptions of well-known parts are omitted for clarity, and like reference numerals refer to like elements throughout.

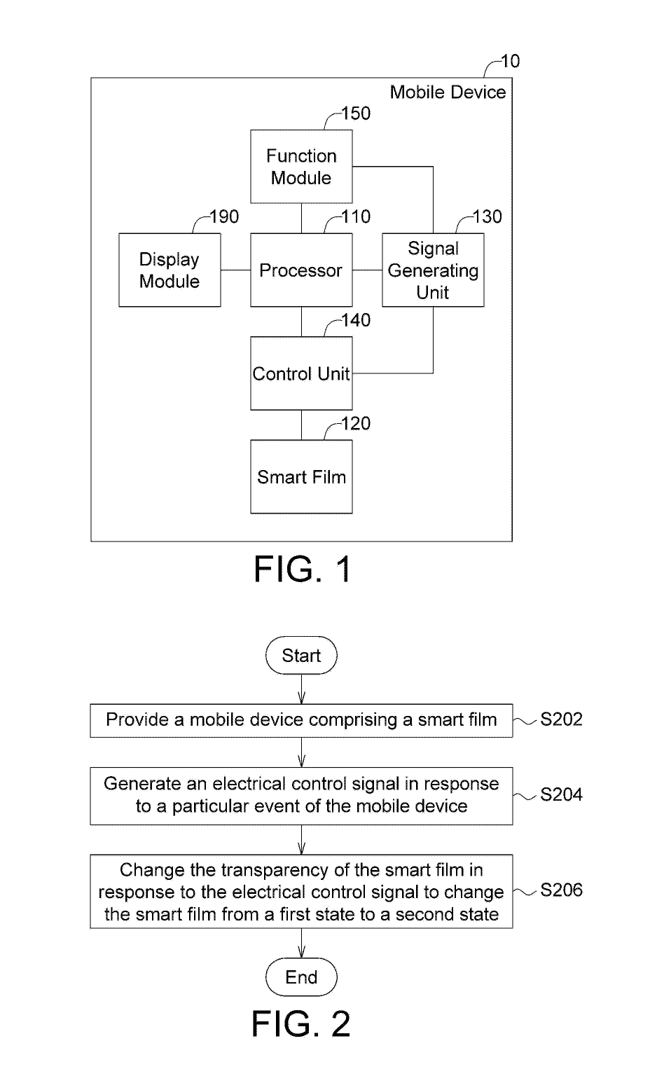

Referring to FIG. 1, FIG. 1 shows a block diagram illustrating a mobile device 10 according to one embodiment of the present invention. The mobile device 10 comprises a processor 110, a smart film 120, a signal generating unit 130, a control unit 140, a function module 150, and a display module 190. This display module 190 could include a hardware display, such as an LCD or LED display or other visual, audio, and/or tactile display, which can display, present or provide notification of any of a variety of messages or data to a user of the mobile device 10. The signal generating unit 130, the control unit 140 and the function module 150 could be realized by using a chip, a circuit in a chip, a firmware, a circuit board including multiple components and connections, or a storage medium storing multiple programming codes, or could be realized by such as a computer system, a server, and electric devices executing corresponding software, firmware or programs. The function module 150 could be a front camera, a back camera, a flash light, a proximity sensor, a laser focus module, a fingerprint identification module, and the like.

The smart film 120 could change its light transmission property in response to applied voltage and thus allow control over the amount of light and heat passing through. The transparency of the smart film 120 could be changed between an opaque or translucent state and a transparent state. For example, when a voltage is applied to the smart film 120, light would be allowed to pass through the smart film 120 with very little scattering and the smart film 120 would be in a transparent state. With no applied voltage, the smart film 120 would be in an opaque or a translucent state and light could not pass through the smart film 120. The degree of the transparency of the smart film 120 can be controlled by the applied voltage. The smart film 120 can have two or more states, such as an opaque state, a transparent state, and a translucent state between the opaque state and the transparent state, according to the applied voltage. The smart film could be a polymer dispersed liquid crystal (PDLC) film, a PDLC glass, a suspended particle device (SPD) film, a SPD glass, a switchable glass, an electrochromic film, an electrochromic glass, a nanocrystal film, and the like.

Referring to FIG. 2, FIG. 2 illustrates a flow diagram for a method for controlling a mobile device according to one embodiment of this invention. To clearly illustrate the operation of the various elements of the above-described embodiments and the present embodiment, the method for controlling a mobile device is described with the following detailed description of a flowchart below. However, those skilled in the art can understand, the method of the present embodiment is applied but not limited to the device 10 in FIG. 1, and it is not limited to the order of the steps of the flowchart. Although the example technique involves operations being performed in a specific order, variants of the technique according to some embodiments can involve these or different operations being performed in different orders.

Please refer to FIGS. 1 and 2. According to an embodiment of the present invention, the process begins at step S202. At step S202, the mobile device 10 is provided. The mobile device 10 comprising a body (not illustrated in FIG. 1) and the smart film 120. The body has a first surface and a second surface facing to the first surface. The smart film 120 could be disposed on a particular area which is located on at least one of the first surface and the second surface. In another embodiment, the mobile device 10 could comprise two smart films 120, wherein one of the smart films 120 is disposed on a particular area which is located on the first surface and another one of the smart films 120 is disposed on a particular area which is located on the second surface. In another embodiment, the mobile device 10 could comprise two smart films 120, wherein both of the smart films 120 are disposed on two particular areas which are located on the first surface or the second surface. For example, the first surface is the front surface of the body where e.g. a touch screen, a front camera or a proximity sensor is configured, and the second surface is the back surface of the body where e.g. a back camera is configured.

At step S204, when a particular event is triggered, the processor 110 notifies the signal generating unit 130 of the particular event, and the signal generating unit 130 generates an electrical control signal in response to the particular event of the mobile device. The electrical control signal in response to the particular event is transmitted to the control unit 140. In one embodiment, the particular event is that a function module, such as a front camera, a back camera, a flash light, a proximity sensor, a laser focus module, and a fingerprint identification module, of the mobile device 10 is activated. In another embodiment, the particular event is that the mobile device receives at least one of an incoming call, a message, such as a text message, a Line message, a Facebook message, a Hangout message, and etc., a notification from a social media server, and a mail. In other embodiment, the particular event is that a setting value of the mobile device is changed, for example, a user changes a setting value related to the color of the back of the mobile device 10, or the mobile device 10 resumes from a suspend state or a sleep mode, that is, a setting value related to the power state of the mobile device 10 is changed.

Next, at step S206, the control unit 140 changes the transparency of the smart film 120 in response to the electrical control signal to change the smart film 120 from a first state to a second state. For example, in response to the electrical control signal, the control unit 140 could apply a voltage to the smart film 120 to adjust the light transmission property of the smart film 120 from an opaque state to a transparent state. When a voltage is applied to the smart film 120, the molecules of the smart film 120 are forced into alignment, rendering it transparent. Without applying voltage, the molecules of the smart film 120 are disordered, and this prevents light from penetrating the film, rendering it opaque.

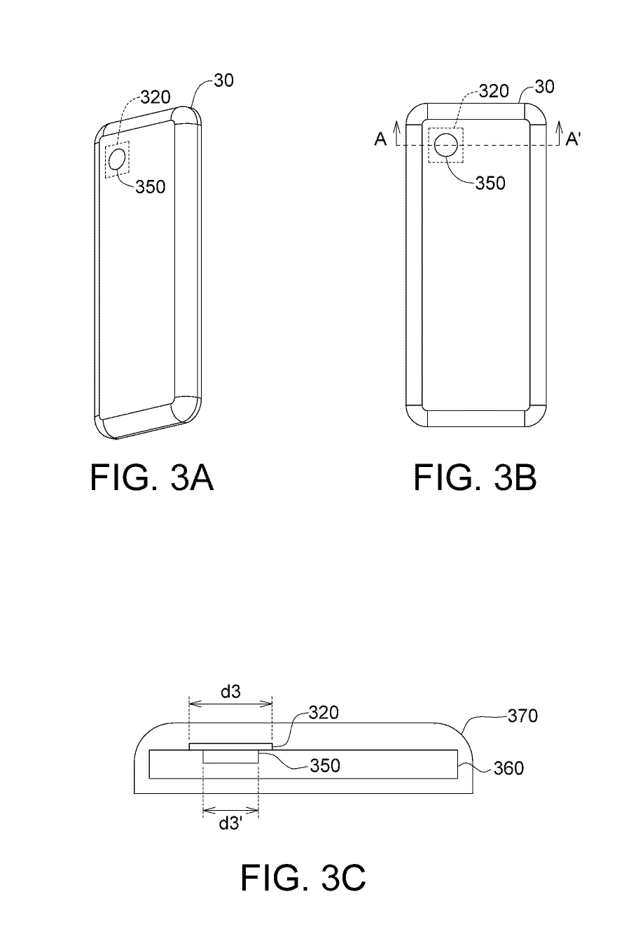

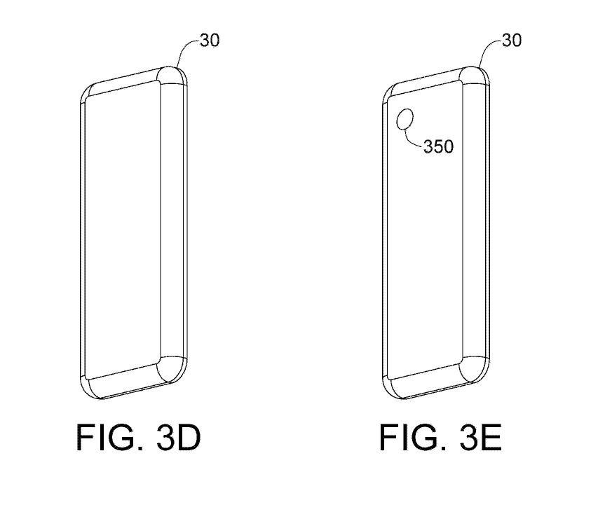

Hereinafter, the accompanying drawings and specific embodiments of the present invention will be described in further detail. Below with reference to FIGS. 3A-3C, according to one embodiment of this invention, FIG. 3A illustrates a perspective view of a mobile device 30, FIG. 3B shows a top view of the back surface of the mobile device 30, and FIG. 3 shows a cross-sectional view of the mobile device 30 taken along the cross-sectional line A-A′ in FIG. 3B. In this embodiment, the mobile device 30 is a smart phone. It should be understood that the mobile device 30 could be but not limited to a mobile phone, a smart phone, a tablet, a personal digital assistant, and the like. The mobile device 30 comprises a housing 370, a body 360, a smart film 320, and a back camera 350. The body 360 has a first surface and a second surface facing to the first surface, for example, the first surface is the front surface of the body 360 and the second surface is the back surface of the body 360. The back camera 350 is configured on the back surface (the second surface) of the body 360. The smart film 320 is disposed on a particular area which is located on the back of the body 360, and the back camera 350 is disposed corresponding to the particular area.

Referring to FIG. 3C, FIG. 3C illustrates a cross-sectional view of the mobile device 30 taken along the cross-sectional line A-A′ in FIG. 3B. The mobile device 30 includes a housing 370, a body 360, a smart film 320, and a back camera 350. The smart film 320 is located between the back camera 350 and the housing 370 and located above the back camera 350. In this embodiment, the smart film 320 is entirely overlapped with and above the back camera 350, and the smart film 320 has a width (d3) equal to or greater than a width (d3′) of the back camera 350. In this embodiment, the entire structure of the housing 370 is made of transparent materials, such as a transparent glass, and the housing 370 is a transparent housing. In some other embodiments, the portion of the housing 370 covering the smart film 320 is transparent, and the other portions of the housing 370 may be transparent or not transparent depending on actual needs.

Referring to FIGS. 3D and 3E, FIG. 3D illustrates a schematic diagram of the mobile device 30 when the smart film disposed above the back camera 350 is in an opaque state (non-transparent state), and FIG. 3E illustrates a schematic diagram of the mobile device 30 when the smart film disposed above the back camera 350 is in a transparent state.

With no applied voltage, the smart film 320 would be in an opaque state (or a translucent state) and light could not pass through the smart film 320. The back camera 350 is blocked by the smart film 320, and a user of the mobile device 30 would not see the back camera 350. The mobile device 30 looks sleek and has no openings on the back surface of the housing 370, as illustrated in FIG. 3D.

When the back camera 350 of the mobile device 30 is activated, e.g. the back camera 350 is enabled when a user of the mobile device 30 wants to take photos or videos, a user uses the back camera via Line, Facebook, WhatsApp, and the like instant messaging applications, or an application related to the back camera 350 is launched, an electrical control signal is generated and transmitted to a control unit for changing the transparency of the smart film 320 and a voltage is applied to the smart film 320. The transparency of the smart film 320 would be changed from an opaque state (or a translucent state) to a transparent state in response to the electrical control signal. The light transmission property of the smart film 320 is adjusted from an opaque state (or a translucent state) to a transparent state. When the smart film 320 is in the transparent state, the user could find and see the back camera 350, as illustrated in FIG. 3E, and the user could take photos or videos.

In addition, the smart film 120 can be used as a filter such as a color filter or ultraviolet (UV) filter. For example, because the degree of the transparency of the smart film 120 can be controlled by the applied voltage, the smart film 120 can be in different states according to different applied voltages, for example, an opaque state, a translucent state and a transparent state. When the smart file 120 is in the translucent state, the translucent smart film 120 can be deemed as a filter to absorb part of the light.

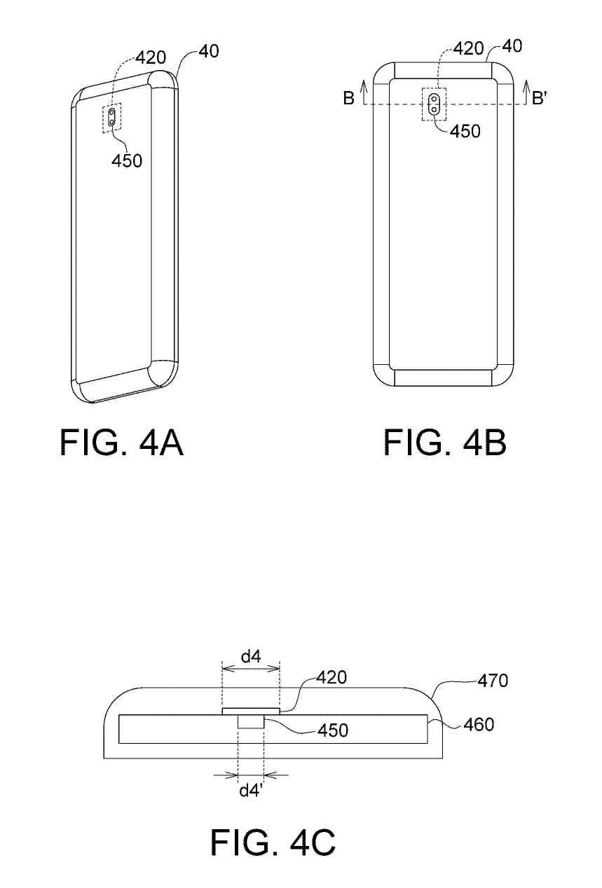

Referring to FIGS. 4A-4C, according to one embodiment of this invention, FIG. 4A illustrates a perspective view of a mobile device 40, FIG. 4B shows a top view of the back side of the mobile device 40 and FIG. 4C shows a cross-sectional view of the mobile device 40. The mobile device 40 comprises a housing 470, a body 460, a smart film 420, and a flash light 450. The flash light 450 is configured on the back surface of the body 460. The smart film 420 is disposed on a particular area which is located on the back surface of the body 460, and the flash light 450 is disposed corresponding to the particular area.

Referring to FIG. 4C, FIG. 4C illustrates a cross-sectional view of the mobile device 40 taken along the cross-sectional line B-B′ in FIG. 4B. The mobile device 40 includes a housing 470, a body 460, a smart film 420, and a flash light 450. The smart film 420 is located between the flash light 450 and the housing 470 and located above the flash light 450. In this embodiment, the smart film 420 is entirely overlapped with and above the flash light 450, and the smart film 420 has a width (d4) equal to or greater than a width (d4′) of the flash light 450.

When the flash light 450 of the mobile device 40 is activated, e.g. a camera related to the flash light 450 is enabled when a user wants to take photos or videos, or an application related to the flash light 450 is launched, a voltage is applied to the smart film 420. The transparency of the smart film 420 would be changed from a first state to a second state, for example, from an opaque state to a transparent state. When the smart film 420 is in the transparent state, the user could find and see the flash light 450 and the flash light 450 functions properly. Because the degree of the transparency of the smart film 420 can be controlled by the applied voltage or power, the flash light 450 could be controlled and used as a dual-color flash by adjusting the transparency of the smart film 420.

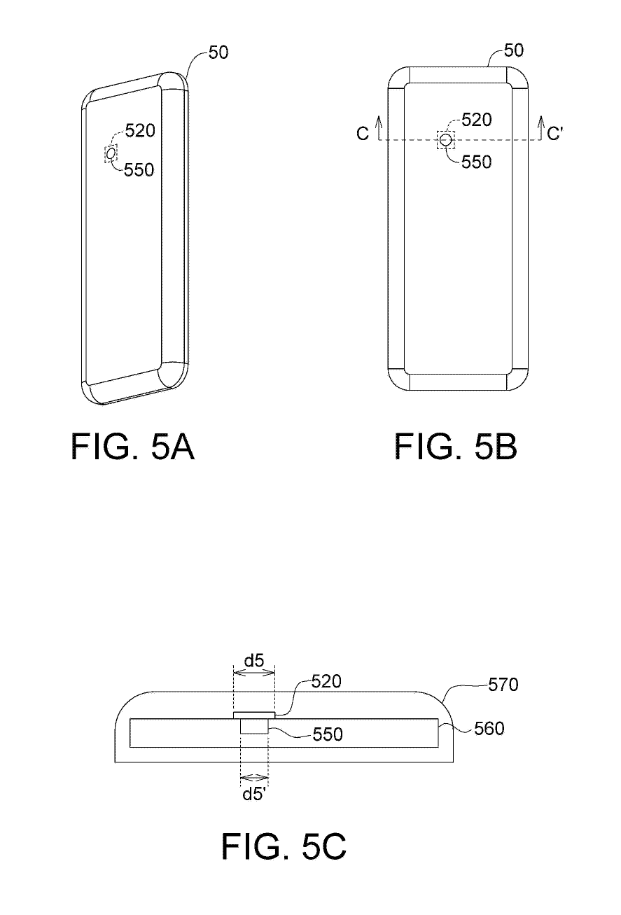

Referring to FIGS. 5A-5C, according to one embodiment of this invention, FIG. 5A illustrates a perspective view of a mobile device 50, FIG. 5B shows a top view of the back side of the mobile device 50 and FIG. 3C shows a cross-sectional view of the mobile device 50. The mobile device 50 comprises a housing 570, a body 560, a smart film 520, and a laser focus module 550. The laser focus 550 is configured on the back surface of the body 560. The smart film 520 is disposed on a particular area which is located on the back surface of the body 560, and the laser focus module 550 is disposed corresponding to the particular area.

Referring to FIG. 5C, FIG. 5C illustrates a cross-sectional view of the mobile device 50 taken along the cross-sectional line C-C′ in FIG. 5B. The mobile device 50 includes a housing 570, a body 560, a smart film 520, and a laser focus module 550. The smart film 520 is located between the laser focus module 550 and the transparent housing 570 and located above the laser focus module 550. In this embodiment, the smart film 520 is entirely overlapped with and above the laser focus module 550, and the smart film 520 has a width (d5) equal to or greater than a width (d5′) of the laser focus module 550.

When the laser focus module 550 of the mobile device 50 is activated, e.g. a camera related to the laser focus module 550 is enabled when a user wants to take photos or videos, or an application related to the laser focus module 550 is launched, a voltage is applied to the smart film 520. The transparency of the smart film 520 would be changed from an opaque state to a transparent state. When the smart film 520 is in the transparent state, the user could find and see the laser focus module 550.

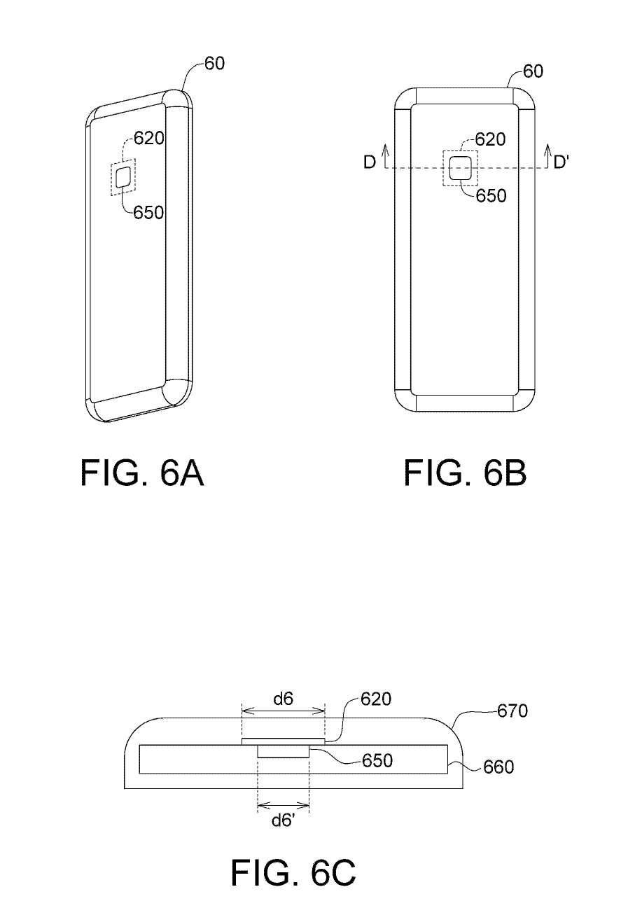

Referring to FIGS. 6A-6C, according to one embodiment of this invention, FIG. 6A illustrates a perspective view of a mobile device 60, FIG. 6B shows a top view of the back side of the mobile device 60 and FIG. 6C shows a cross-sectional view of the mobile device 60. The mobile device 60 comprises a housing 670, a body 660, a smart film 620, and a fingerprint identification module 650. The fingerprint identification module 650 is configured on the back surface of the body 660. The smart film 620 is disposed on a particular area which is located on the back surface of the body 660, and the fingerprint identification module 650 is disposed corresponding to the particular area.

Referring to FIG. 6C, FIG. 6C illustrates a cross-sectional view of the mobile device 60 taken along the cross-sectional line D-D′ in FIG. 5B. The mobile device 60 includes a housing 670, a body 660, a smart film 620, and a fingerprint identification module 650. The smart film 620 is located between the fingerprint identification module 650 and the housing 670 and located above the fingerprint identification module 650. In this embodiment, the smart film 620 is entirely overlapped with and above the fingerprint identification module 650, and the smart film 620 has a width (d6) equal to or greater than a width (d6′) of the fingerprint identification module 650.

When the fingerprint identification module 650 of the mobile device 60 is activated, e.g. there is a need for mobile payment or identifying a user of the mobile device 60, a voltage is applied to the smart film 620. The transparency of the smart film 620 would be changed from an opaque state (or a translucent state) to a transparent state. When the smart film 620 is in the transparent state, the user could find and see the fingerprint identification module 650.

In this embodiment, the fingerprint identification module 650 is disposed on the back surface of the body 660, but in other embodiments, fingerprint identification module 650 can be disposed on the front surface of the body 660.

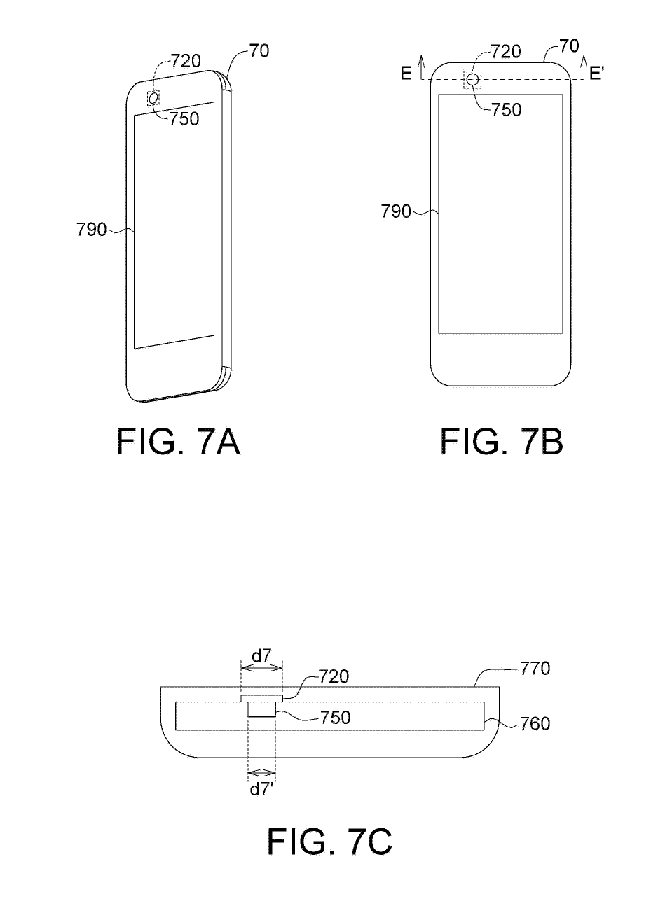

Referring to FIGS. 7A-7C, according to one embodiment of this invention, FIG. 7A illustrates a perspective view of a mobile device 70, FIG. 7B shows a top view of the front side of the mobile device 70 and FIG. 7C shows a cross-sectional view of the mobile device 70. The mobile device 70 comprises a housing 770, a body 760, a display module 790, a smart film 720, and a front camera 750. The front camera 750 is configured on the front surface of the body 760. The smart film 720 is disposed on a particular area which is located on the front surface of the body 760, and the front camera 750 is disposed corresponding to the particular area.

Referring to FIG. 7C, FIG. 7C illustrates a cross-sectional view of the mobile device 70 taken along the cross-sectional line E-E′ in FIG. 7B. The mobile device 70 includes a housing 770, a body 760, a smart film 720, and a front camera 750. The smart film 720 is located between the front camera 750 and the housing 770 and located above the front camera 750. In this embodiment, the smart film 720 is entirely overlapped with and above the front camera 750, and the smart film 720 has a width (d7) equal to or greater than a width (d7′) of the front camera 750.

When the front camera 750 of the mobile device 70 is activated, e.g. the front camera 750 is enabled when a user of the mobile device 30 wants to take photos or make a video call, a user uses the front camera 750 via Line, Facebook, WhatsApp, and the like applications, or an application related to the front camera 750 is launched, a voltage is applied to the smart film 720 and the transparency of the smart film 720 would be changed from an opaque state (or a translucent state) to a transparent state. When the smart film 720 is in the transparent state, the user could find and see the front camera 750 and the front camera 750 would function properly.

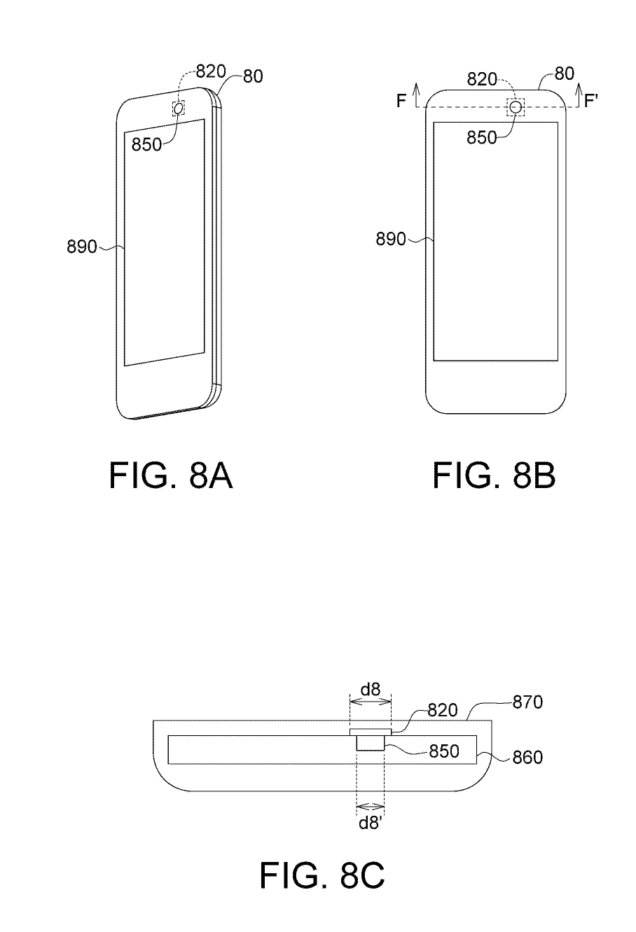

Referring to FIGS. 8A-8C, according to one embodiment of this invention, FIG. 8A illustrates a perspective view of a mobile device 80, FIG. 8B shows a top view of the front side of the mobile device 80 and FIG. 8C shows a cross-sectional view of the mobile device 80. The mobile device 80 comprises a housing 870, a body 860, a display module 890, a smart film 820, and a proximity sensor 850. The proximity sensor 850 is configured on the front surface of the body 860. The smart film 820 is disposed on a particular area which is located on the front surface of the body 860, and the proximity sensor 850 is disposed corresponding to the particular area.

Referring to FIG. 8C, FIG. 8C illustrates a cross-sectional view of the mobile device 80 taken along the cross-sectional line F-F′ in FIG. 8B. The mobile device 80 includes a housing 870, a body 860, a smart film 820, and a proximity sensor 850. The smart film 820 is located between the proximity sensor 850 and the transparent housing 870 and located above the proximity sensor 850. In this embodiment, the smart film 820 is entirely overlapped with and above the proximity sensor 850, and the smart film 820 has a width (d8) equal to or greater than a width (d8′) of the proximity sensor 850.

When the proximity sensor 850 of the mobile device 80 is activated, e.g. when a phone call is made, or a real-time voice call via an instant messaging application is established, the proximity sensor 850 would be activated, a voltage is applied to the smart film 820. The transparency of the smart film 820 would be changed from an opaque state (or a translucent state) to a transparent state. When the smart film 820 is in the transparent state, the proximity sensor 850 would function properly.

Based on the above-described embodiments, the smart films 420, 520, 620, 720, and 820 are respectively disposed on particular areas which are located on the first surface or the second surface of the bodies 360, 460, 560, 660, 760, and 860, wherein the first surface is the front surface of the bodies where a touch screen is disposed, and the second surface is the back surface of the bodies. The function modules, e.g. the flash light 450, the laser focus module 550, the fingerprint identification module 650, the front camera 750, and the proximity sensor 850, are respectively disposed corresponding to the particular areas, and the smart films 420, 520, 620, 720, and 820 are respectively located between the function modules and the housings 470, 570, 670, 770, and 870. In some embodiments, the entire structure of the housing 470/570/670/770/870 is transparent, for example, the housing 470/570/670/770/870 could be a transparent glass housing. In the other embodiments, the portion of the housing 470/570/670/770/870 covering the smart film 420/520/620/720/820 is transparent, and the other portions of the housing 470/570/670/770/870 may be transparent or not transparent depending on actual needs.

With no applied voltage or power, the smart films 420, 520, 620,720, and 820 would be in an opaque or translucent state and light could not pass through the smart films 420, 520, 620,720, and 820. The flash light 450, the laser focus module 550, the fingerprint identification module 650, the front camera 750, and the proximity sensor 850 are blocked respectively by the smart films 420, 520, 620, 720, and 820, and users of the mobile devices 40, 50, 60, 70, and 80 would not see the above-described function modules. The mobile devices 40, 50, 60, 70, and 80 look sleek and have no openings on their housings.

When the smart films 420, 520, 620, 720, and 820 change their light transmission properties or transparency in response to applied voltage to be in a transparent state, the flash light 450, the laser focus module 550, the fingerprint identification module 650, the front camera 750, and the proximity sensor 850 show up and function properly and well.

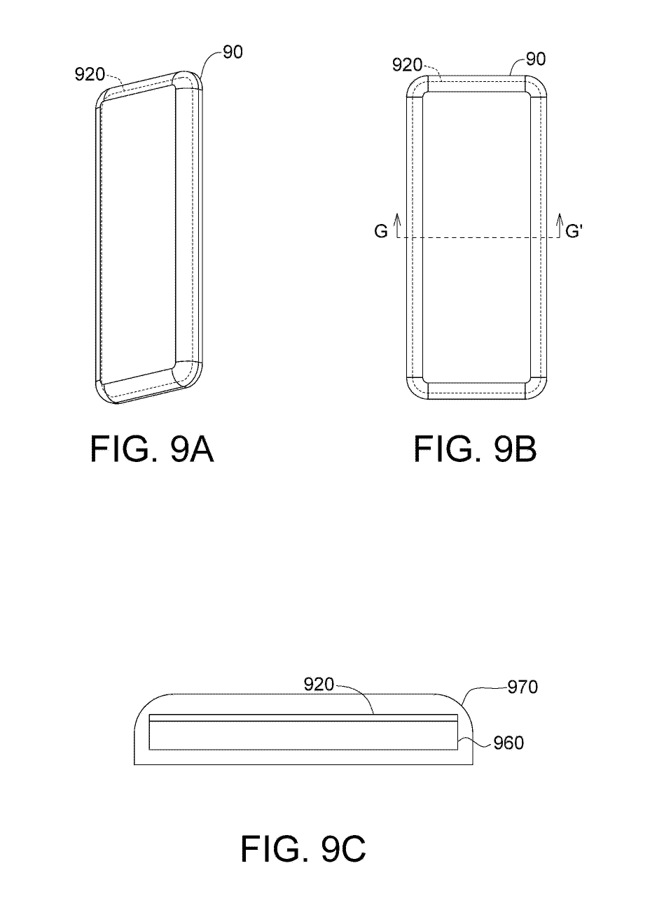

Referring to FIGS. 9A-9C, according to one embodiment of this invention, FIG. 9A illustrates a perspective view of a mobile device 90, FIG. 9B shows a top view of the back side of the mobile 90 and FIG. 9C shows a cross-sectional view of the mobile device 90. The mobile device 90 comprises a housing 970, a body 960 and a smart film 920. The smart film 920 is disposed on the back surface of the body 960. The back surface of the body 960 has a different color than the color of the smart film 920 when the smart film 920 is in an opaque state or a translucent state. For example, when the smart film 920 is in an opaque state, the smart film 920 appears a color of milky white. The back surface of the body 960 would be colored in red, blue, yellow, pink, silver, or any colors different from milky white.

Referring to FIG. 9C, FIG. 9C illustrates a cross-sectional view of the mobile device 90 taken along the cross-sectional line G-G′ in FIG. 9B. The mobile device 90 includes a housing 970, a body 960 and a smart film 920. The smart film 920 is located between the body 960 and the housing 970 and located above the body 960. In this embodiment, the smart film 920 is entirely overlapped with and above the body 960, and the smart film 920 has a width equal to a width of the body 960. A color block is painted on the back surface of the body 960.

In the setting menu of the mobile device 90, there is an option for user to change the color of the back surface of the mobile device 90. When a user of the mobile device 90 changes the setting for changing the color of the back surface of the mobile device 90, a voltage is applied to the smart film 920. The transparency of the smart film 920 would be changed from an opaque state (or a translucent state) to a transparent state, e.g. the color of the smart film 920 is changed from milky white to transparent, and when the smart film 920 is in the transparent state, the user could see the color of the back surface of the body 960, e.g. red color or silver color. Because the degree of the transparency of the smart film 920 can be controlled by the applied voltage, the back surface of the mobile device 90 could show any color level between the color of the smart film 920 when it is opaque or translucent and the color of the back side of the body 960. The color of the back surface of the mobile device 90 which a user sees could be determined by adjusting the transparency of the smart film 920.

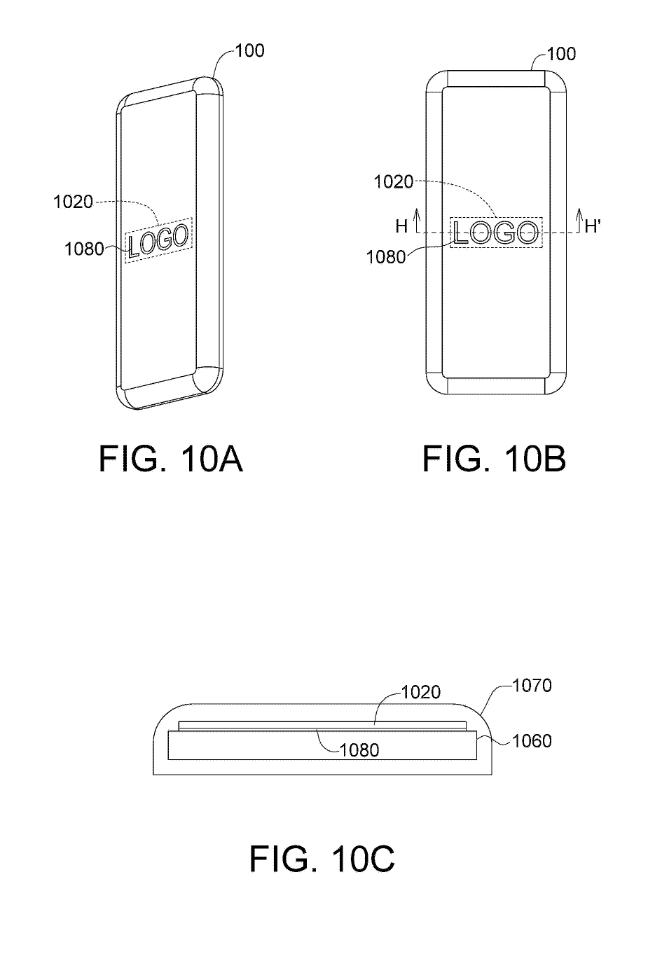

Referring to FIGS. 10A-10C, according to one embodiment of this invention, FIG. 10A illustrates a perspective view of a mobile device 100, FIG. 10B shows a top view of the back side of the mobile device 100, and FIG. 10C shows a cross-sectional view of the mobile device 100. The mobile device 100 comprises a housing 1070, a smart film 1020, a logo 1080 and a body 1060. The smart film 1020 is disposed on a particular area which is located on the back surface of the body 1060, and the logo 1080 is disposed corresponding to the particular area. In other embodiments, the logo 1080 could be painted or etched on the back surface of the body 1060.

Referring to FIG. 10C, FIG. 10C illustrates a cross-sectional view of the mobile device 100 taken along the cross-sectional line H-H′ in FIG. 10B. The mobile device 100 includes a housing 1070, a body 1060, a smart film 1020, and a logo 1080. The smart film 1020 is located between the logo 1080 and the housing 1070 and located above the logo 1080. In this embodiment, the smart film 1020 is entirely overlapped with and above the logo 1080, and the smart film 1020 has a width equal to or larger than a width of the logo 1080.

When the mobile device 100 resumes from a suspend state or the mobile device 100 is powered on, a setting value related to power states, e.g. working state and sleep or suspend state of the mobile device 100, is changed, and then a voltage is applied to the smart film 920. The transparency of the smart film 1020 would be changed from an opaque state (or a translucent state) to a transparent state, and when the smart film 1020 is in the transparent state, the logo 1080 could show up and the user could see the logo 1080.

In some embodiments, the entire structure of the housing 970/1070 is transparent, for example, the housing 970/1070 could be a transparent glass housing. In the other embodiments, the portion of the housing 970/1070 covering the smart film 920/1020 is transparent, and the other portions of the housing 970/1070 may be transparent or not transparent depending on actual needs.

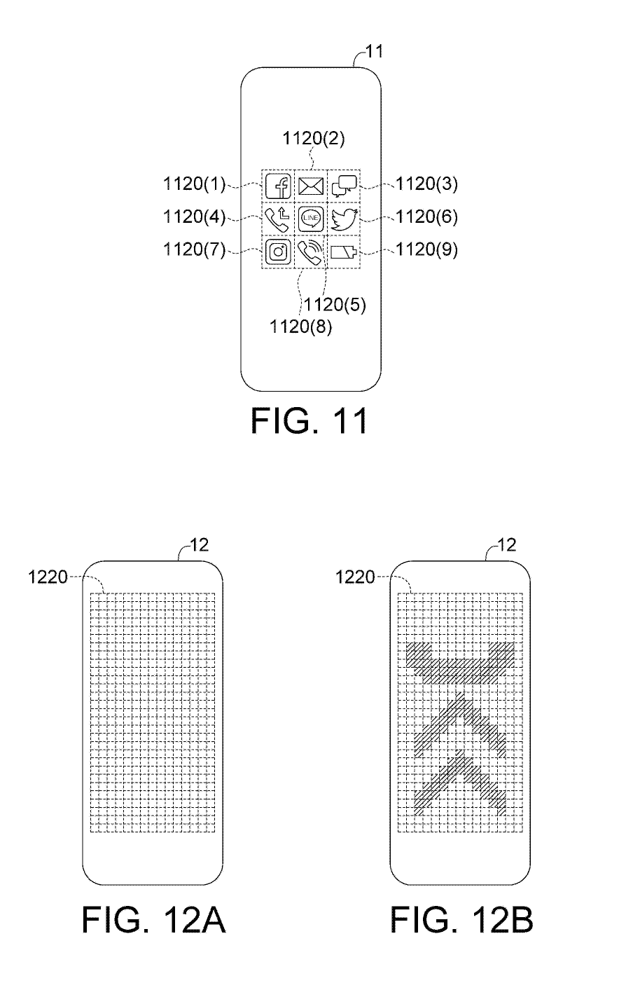

Please refer to FIG. 11 illustrating a top view of the back side of a mobile device 11 according to one embodiment of the present invention. The mobile device 11 includes smart film 1120, and the smart film 1120 is entirely overlapped with and above a pattern related to an application. The smart film 1120 and the pattern are disposed on the back surface of the body of the mobile device 11. In this embodiment, the mobile device 11 includes 9 smart films 1120(1), 1120(2), 1120(3), 1120(4), 1120(5), 1120(6), 1120(7), 1120(8), and 1120(9) disposed corresponding to 9 patterns respectively related to different applications, such as Facebook, mail, message, missed call, incoming call, Line, Twitter, Instagram, and low battery indication. The smart films 1120(1), 1120(2), 1120(3), 1120(4), 1120(5), 1120(6), 1120(7), 1120(8), and 1120(9) are disposed above their respective patterns, arranged in a matrix form and controlled individually. However, it is not limited thereto, in other embodiments, the number of smart film 1120 and the number of the patterns may be only one or the other amount. The application related to a pattern is not limited to the above-described applications.

For example, when the battery of the mobile device 11 needs charging, a particular event related to low battery indication is triggered and an electrical control signal is generated in response to the particular event. A voltage is applied to the smart film 1120(9), and the transparency of the smart film 1120(9) would be changed from an opaque state (or a translucent state) to a transparent state. When the smart film 1120(9) is in the transparent state, the pattern related to low battery indication could show up and the user would be informed that the mobile device 11 needs charging.

For example, when the user of the mobile device 11 missed a phone call, a particular event related to missed calls is triggered and an electrical control signal is generated in response to the particular event. A voltage is applied to the smart film 1120(4), and the transparency of the smart film 1120(4) would be changed from an opaque state (or a translucent state) to a transparent state in response to the particular event. When the smart film 1120(4) is in the transparent state, the pattern related to missed calls could show up and the user would be informed that he/she missed a phone call.

For example, when a friend of the user of the mobile device 11 replies a Facebook post written by the user, the mobile device 11 would receive a notification from a Facebook server. A particular event related to the notification is triggered and an electrical control signal is generated in response to the particular event. A voltage is applied to the smart film 1120(1), and the transparency of the smart film 1120(1) would be changed from an opaque state (or a translucent state) to a transparent state. When the smart film 1120(1) is in the transparent state, the pattern related to the Facebook notification from the Facebook server could show up and the user would be informed a notification related to Facebook.

Referring to FIGS. 12A and 12B, FIGS. 12A and 12B show top views of the back surface of a mobile device 12 according to one embodiment of this invention. The mobile device 12 includes a plurality of smart films, and the plurality of smart films is arranged in a matrix form to from a smart film matrix 1220, as shown in FIG. 12A. The smart films of the smart film matrix 1220 are controlled individually in response to a particular event. For example, when the mobile device 12 receives an incoming call, voltages are respectively and individually applied to some target smart films of the smart film matrix 1220 in response to the incoming call, and the transparency of the target smart films would be change from an opaque state (or a translucent state) to a transparent state and then the color of the back surface of the body of the mobile device 12 appears. The target smart films form a particular matrix display to appear an incoming call, as illustrated in FIG. 12B.

Based on the above-described embodiments, the smart films 920, 1020, and 1120, and the smart film matrix 1220 are disposed on particular areas which are located on the second surface (the back surface) of the bodies. The color block and the logo could be also seen as a pattern herein. Thus, a pattern herein is related to a color block, a logo and an application and could be disposed corresponding to a particular area. The smart films 920, 1020, and 1120 and the smart film matrix 1220 are respectively located between patterns and the housings.

With no applied voltage or power, the smart films 920, 1020, and 1120, and the smart film matrix 1220 would be in an opaque or translucent state and light could not pass through the smart films 920, 1020, and 1120, and the smart film matrix 1220. The patterns related to a color block, a logo and different applications are blocked respectively by the smart films 920, 1020, and 1120, and the smart film matrix 1220, and the user would not see the patterns related to the color block, the logo and different applications. The mobile devices 90, 100, 11, and 12 look simple, sleek and stylish.

When the smart films 920, 1020, and 1120 change their light transmission properties or transparency in response to applied voltage to be in a transparent state, the patterns related to the color block, the logo or different applications show up. In addition, some of smart films in the smart film matrix 1220 would be changed from an opaque (or a translucent state) to a transparent state to form a particular matrix display in response to an incoming call, a message, a notification from a social media server, or a mail, and the like.

In above-described embodiments, the mobile devices 11, 12, 30, 40, 50, 60, 70, 80, 90, and 100 described above could be but not limited to a mobile phone, a smart phone, a tablet, a personal digital assistant, and the like. The smart film is changed from a first state to a second state, wherein the first state is an opaque state and the second state is a transparent state. However, in other embodiments, when the smart film is changed from a first state to a second state, the first state could be a transparent state and the second state could be an opaque state. In some other embodiments, the first state could be one of a transparent state, a translucent state, and an opaque state, and the second state could be one of a transparent state, a translucent state, and an opaque state.

According to embodiments of the present invention, a mobile device includes a smart film, and the transparency of the smart film could be controlled and adjusted by applying a voltage. The smart film is disposed between a function module and the housing of the mobile device or is disposed between a pattern and the housing. When the smart film is in an opaque state, the function module or the pattern is blocked by the smart film and is not seen by the user. The mobile device would look sleek and stylish. When the smart film is in a transparent state, the user could see the function module or the pattern, and the function module works properly. Thus, the conventional openings on a mobile device for function modules, such as a front camera, a back camera, a proximity sensor, a flash light, or a laser focus module, could be hidden by the smart film, and the mobile device looks sleek and stylish when the function modules do not need to be activated.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method for controlling a mobile device, comprising:
providing the mobile device, comprising a body and a smart film, wherein the body has a first surface and a second surface facing to the first surface, the smart film is disposed on a particular area which is located on at least one of the first surface and the second surface;
generating an electrical control signal in response to a particular event of the mobile device, and the particular event is that the mobile device receives at least one of an incoming call, an message, a notification from a social media server, and a mail; and
changing the transparency of the smart film in response to the electrical control signal to change the smart film from a first state to a second state.

2. (canceled)

3. (canceled)

4. (canceled)

5. The method according to claim 1, wherein a pattern is disposed on the particular area and located between the smart film and the body, and the pattern is related to one of an application, a color block and a logo.

6. (canceled)

7. The method according to claim 1, wherein the first state is an opaque state and the second state is a transparent state.

8. The method according to claim 1, wherein the mobile device comprises a plurality of smart films, and the smart films are arranged in a matrix form and controlled individually.

9. A mobile device comprising:
a body, having a first surface and a second surface facing to the first surface;
a smart film, disposed on a particular area which is located on at least one of the first surface and the second surface;
a signal generating unit, for generating an electrical control signal in response to a particular event of the mobile device, and the particular event is that the mobile device receives at least one of an incoming call, an message, a notification from a social media server, and a mail; and
a control unit, for changing the transparency of the smart film in response to the electrical control signal to change the smart film from a first state to a second state.

10. (canceled)

11. (canceled)

12. (canceled)

13. The mobile device according to claim 9, wherein a pattern is disposed on the particular area and located between the smart film and the body, and the pattern related to one of an application, a color block and a logo.

14. (canceled)

15. The mobile device according to claim 9, wherein the first state is an opaque state and the second state is a transparent state.

16. The mobile device according to claim 9, wherein the mobile device comprises a plurality of smart films, and the smart films are arranged in a matrix form and controlled individually.

17. A mobile device, comprising:
a transparent housing;
a body, having a first surface and a second surface facing to the first surface; and
a smart film, disposed on a particular area which is located on at least one of the first surface and the second surface, and placed between the transparent housing and the body;
wherein, the transparency of the smart film is changed from a first state to a second state in response to an electrical control signal that is in response to a particular event of the mobile device, and the particular event is that the mobile device receives at least one of an incoming call, an message, a notification from a social media server, and a mail.

18. (canceled)

19. The mobile device according to claim 17, wherein a function module is disposed corresponding to the particular area, and the smart film is located between the function module and the transparent housing.

20. The mobile device according to claim 19, wherein the function module is one of a front camera, a back camera, a flash light, a proximity sensor, a laser focus module, and a fingerprint identification module.

21. The mobile device according to claim 17, wherein a pattern is disposed at the particular area, and the smart film is located between the pattern and the transparent housing.

22. The mobile device according to claim 21, wherein the pattern is related to one of an application, a color block and a logo.

23. The mobile device according to claim 17, wherein the mobile device comprises a plurality of smart films, and the smart films are arranged in a matrix form and controlled individually.
